(19) United States
(12) Patent Application Publication
(10) Pub. No.: US 2022/0326860 A1
(43) Pub. Date: Oct. 13, 2022

(54) METHOD AND APPARATUS TO PERFORM BANK SPARING FOR ADAPTIVE DOUBLE DEVICE DATA CORRECTION

(71) Applicant: Intel Corporation, Santa Clara, CA (US)

(72) Inventors: Jun LI, Shanghai (CN); Subhankar PANDA, Portland, OR (US); Gaurav PORWAL, Portland, OR (US); Feiting WANYAN, Shanghai (CN)

(21) Appl. No.: 17/850,455

(22) Filed: Jun. 27, 2022

(30) Foreign Application Priority Data
May 27, 2022 (CN) PCT/CN2022/095433

(51) Int. Cl. G06F 3/06

(52) U.S. Cl. CPC G06F 3/0619; G06F 3/0653; G06F 3/0673

(57) ABSTRACT

A dedicated bank-based error counter is provided for a respective bank of a Dynamic Random Access Memory (DRAM). The dedicated bank-based error counter for the bank is stored in memory resources. A Basic Input/Output System (BIOS) System Management Interrupt (SMI) handler triggers Adaptive Double Device Data Correction (ADDDC) bank sparing if the error count for the respective bank equals or exceeds a per bank ADDDC threshold.

### CLAIM OF PRIORITY

This application claims the benefit of priority to Patent Cooperation Treaty (PCT) Application No. PCT/CN2022/095433 filed May 27, 2022, entitled “METHOD AND APPARATUS TO PERFORM BANK SPARING FOR ADAPTIVE DOUBLE DEVICE DATA CORRECTION.” The entire content of that application is incorporated by reference.

### FIELD

This disclosure relates to memory management and in particular to memory error management.

### BACKGROUND

Sparing techniques are employed to survive hard Dynamic Random Access Memory (DRAM) failures or hard errors. A hard error refers to an error with a physical device which prevents it from reading and/or writing correctly, and is distinguished from transient errors which are intermittent failures. Techniques are known for Single Device Data Correction (SDDC), Double Device Data Correction (DDDC) and Adaptive Double Device Data Correction (ADDDC) that provide error checking and correction (ECC) to protect against memory failure due to hard failures in DRAM.

### BRIEF DESCRIPTION OF THE DRAWINGS

Features of embodiments of the claimed subject matter will become apparent as the following detailed description proceeds, and upon reference to the drawings, in which like numerals depict like parts, and in which:

FIG. 1 is a block diagram of a memory subsystem that includes a memory and a memory controller;

FIG. 2 is a block diagram of an embodiment of a system with a memory subsystem including at least one memory module coupled to a memory controller;

FIG. 3 is a block diagram illustrating one rank in the memory and registers associated with the rank in the error manager in the memory subsystem shown in FIG. 1;

FIG. 4 is a block diagram illustrating an array of bank error counters for the rank shown in FIG. 3;

FIG. 5 is a flowgraph illustrating a method performed in the system shown in FIG. 1 to perform error management using the array of bank error counters for the rank shown in FIG. 4; and

FIG. 6 is a block diagram of an embodiment of a computer system that includes the memory subsystem.

Although the following Detailed Description will proceed with reference being made to illustrative embodiments of the claimed subject matter, many alternatives, modifications, and variations thereof will be apparent to those skilled in the art. Accordingly, it is intended that the claimed subject matter be viewed broadly, and be defined as set forth in the accompanying claims.

### DESCRIPTION OF EMBODIMENTS

SDDC checks and corrects single-bit or multiple-bit memory faults that affect an entire single DRAM device. ADDDC is an error checking code format that provides error checking and correction to protect against memory failures in two, sequential, DRAM devices. ADDDC can be implemented at a rank or a bank granularity. A rank is a set of DRAM devices that are connected to the same chip select. A bank is an array of memory locations within a DRAM device.

Sparing operations copy the contents of memory to another location or another format. Examples of sparing operations include rank sparing, where data from a bad rank is copied to a spare rank, and device sparing where contents of a bad DRAM device are copied to another DRAM device.

ADDDC can be implemented at a rank or a bank granularity. Instead of using system addresses, ADDDC sparing uses memory addresses (bank/row/column (for ADDDC implemented at a rank granularity) or row/column (for ADDDC implemented at a bank granularity) address) in increasing order. In virtual lockstep (VLS), a cache line is stored across two memory locations. The two memory locations can be referred to as Primary and Buddy locations.

If ADDDC is implemented at a bank granularity, a memory failure will only occur to a DRAM bank and will not occur to the entire DRAM device because a bank granularity of a DRAM region enters into virtual lockstep along with a buddy bank, allowing the content of the bank of a failing DRAM device to be copied over to the bank of a spare buddy DRAM device.

ADDDC allows up to two DRAM hard failures to be corrected in a different bank in a rank. When the number of correctable errors exceeds a threshold, a Basic Input/Output System (BIOS) System Management Interrupt (SMI) handler is invoked to select a non-failed bank in the rank and the failed bank in the rank is mapped out by invoking an adaptive virtual lockstep (VLS) algorithm.

Lockstep refers to distributing error correction over multiple memory resources to compensate for a hard failure in one memory resource that prevents deterministic data access to the failed memory resource. A lockstep partnership refers to two portions of memory over which error checking and correction is distributed or shared.

However, the errors per rank can be from different banks/ranks in the same memory device, with the current per-rank error counter. After the current per-rank error counter exceeds a threshold, it is difficult to determine which failed bank/rank in the same memory device is to be mapped out. In one rank (multiple devices), when a correctable error count in different banks that is stored in the per-rank error counter exceeds a threshold, the failed bank/rank (same device) of the last error is mapped to the buddy bank/rank (same device).

For example, if an ADDDC error threshold is N, the number of errors in a first bank is N−1 and the Nth error (last error) is in a second bank, the BIOS SMI handler maps out the second bank to the buddy bank. The first bank with N−1 errors is not handled after ADDDC bank sparing is triggered and the per-rank error count is cleared in the per-rank error counter. The first bank and second bank can be in a same memory device or in different memory devices.

A dedicated bank-based error counter is provided for a respective bank. The dedicated bank-based error counter for the bank is stored in memory resources. The BIOS SMI handler triggers ADDDC sparing when the error count for the respective bank exceeds the per bank ADDDC threshold.

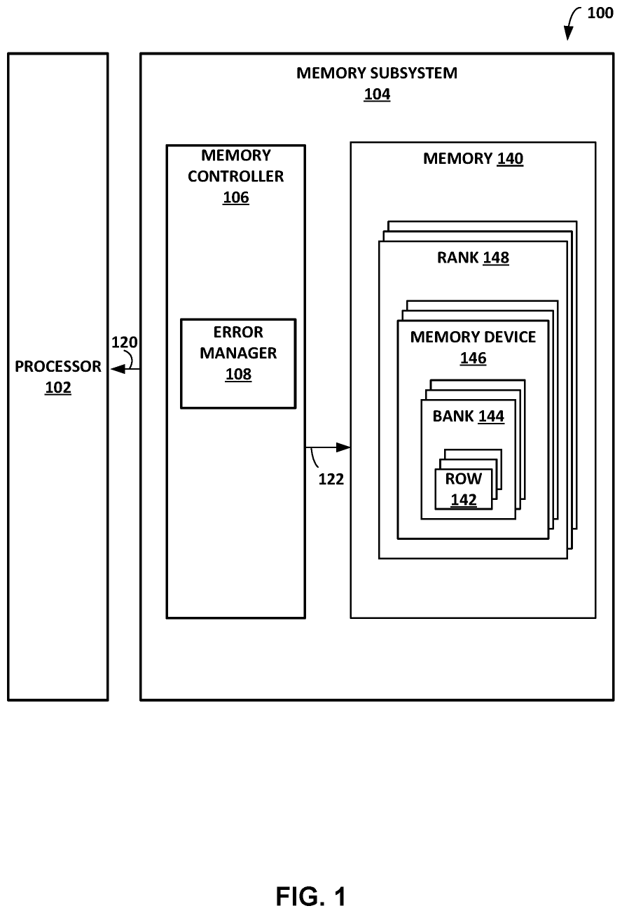

FIG. 1 is a block diagram of compute device 100 that includes a processor 102 and a memory subsystem 104 including a memory 140 and a memory controller 106. Compute device 100 can implement ADDDC to manage hard errors or hard failures.

Processor 102 represents hardware processing resources in compute device 100 that executes code and generates requests to access data and/or code stored in memory 140. Processor 102 can include a central processing unit (CPU), graphics processing unit (GPU), application specific processor, peripheral processor, and/or other processor that can generate requests to read from and/or write to memory 140. Processor 102 can be or include a single core processor and/or a multicore processor. Processor 102 generates requests to read data from memory 140 and/or to write data to memory 140 through execution of processor instructions. The processor instructions can include code that is stored locally to processor 102 and/or processor instructions (“code”) stored in memory 140.

Memory controller 106 represents logic in compute device 100 that manages access to memory 140. For access requests generated by processor 102, memory controller 106 generates one or more memory access commands to send to memory 140 to service the requests. Memory controller 106 can be a standalone component on a logic platform shared by processor 102 and memory 140 or part of processor 102. The memory controller 106 can be a separate chip or die from processor 102 and integrated on a common substrate with a processor die/chip as a system on a chip (SoC). One or more memory resources of memory 140 can be integrated in a SoC with processor 102 and/or memory controller 106. Memory controller 106 manages configuration and status of memory 140 in connection with managing access to the memory resources.

The memory 140 can be a volatile memory. Volatile memory is memory whose state (and therefore the data stored on it) is indeterminate if power is interrupted to the device. Dynamic volatile memory requires refreshing the data stored in the device to maintain state. One example of dynamic volatile memory includes DRAM (dynamic random access memory), or some variant such as synchronous DRAM (SDRAM). A memory subsystem as described herein may be compatible with a number of memory technologies, such as DDR3 (double data rate version 3, original release by JEDEC (Joint Electronic Device Engineering Council) on Jun. 27, 2007, currently on release 21), DDR4 (DDR version 4, JESD79-4 initial specification published in September 2012 by JEDEC), DDR4E (DDR version 4, extended, currently in discussion by JEDEC), LPDDR3 (low power DDR version 3, JESD209-3B, August 2013 by JEDEC), LPDDR4 (LOW POWER DOUBLE DATA RATE (LPDDR) version 4, JESD209-4, originally published by JEDEC in August 2014), WI02 (Wide I/O 2 (WideIO2), JESD229-2, originally published by JEDEC in August 2014), HBM (HIGH BANDWIDTH MEMORY DRAM, JESD235, originally published by JEDEC in October 2013), DDR5 (DDR version 5, currently in discussion by JEDEC), LPDDR5, originally published by JEDEC in January 2020, HBM2 (HBM version 2), originally published by JEDEC in January 2020, or others or combinations of memory technologies, and technologies based on derivatives or extensions of such specifications. The JEDEC standards are available at www.jedec.org.

The memory 140 includes one or more memory devices 146. In an embodiment, the memory device 146 is a DRAM device. The memory address 122 can include a rank address, a bank address, and a row address and a column address to identify a row 142 in a bank 144 in a memory device 146 in a rank 148 in the memory 140. One or more memory devices 146 are grouped in a rank 148. A memory module (for example, a dual inline memory module (DIMM)) of compute device 100 can include one or two ranks 148. In one embodiment, ranks 148 can include memory devices 140 across physical boards or substrates. Each memory device 146 includes multiple banks 144, which are an addressable group of rows 142.

Memory controller 106 includes error manager 108 (also referred to as error logic or error circuitry) to manage error response, including lockstep configurations. Lockstep partners refer to a pair of banks 144 or ranks 148 or other memory portions that are working in lockstep. The error manager 108 can detect errors and determine an ADDDC state to apply to handle error correction for the error.

The error manager 108 can determine whether the current level of error correction or current lockstep mapping is sufficient to manage known hard errors and can determine when and how to change lockstep partnerships to respond to additional errors that might occur in an existing lockstep partnership. In an embodiment, the error manager 108 issues an SMI interrupt 120 to the processor 102 for each detected memory error. A BIOS SMI handler in the processor checks if the error count for a bank equals or exceeds the per-bank ADDDC threshold. Upon detecting that the error count for a bank exceeds the ADDDC threshold, the BIOS SMI handler in the processor triggers ADDDC bank sparing.

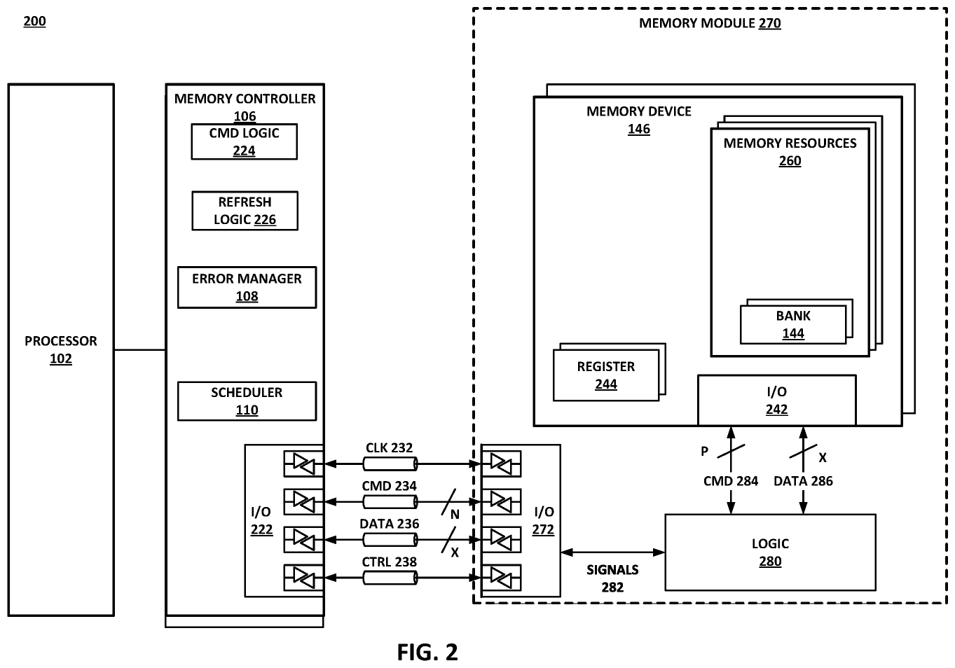

FIG. 2 is a block diagram of an embodiment of a system 200 with a memory subsystem including at least one memory module 270 coupled to a memory controller 106. The memory controller 106 includes the error manager 108 discussed in conjunction with FIG. 1. The memory controller also includes a scheduler 110. System 200 includes a processor 102 and elements of a memory subsystem in a computing device. Processor 102 represents a processing unit of a computing platform that can execute an operating system (OS) and applications, which can collectively be referred to as the host or user of the memory. The OS and applications execute operations that result in memory accesses. Processor 102 can include one or more separate processors. Each separate processor can include a single processing unit, a multicore processing unit, or a combination. The processing unit can be a primary processor such as a CPU (central processing unit), a peripheral processor such as a GPU (graphics processing unit), or a combination. Memory accesses may also be initiated by devices such as a network controller or storage controller. Such devices can be integrated with the processor in some systems (for example, in a System-on-Chip (SoC)) or attached to the processer via a bus (e.g., Peripheral Component Interconnect express (PCIe)), or a combination.

Reference to memory devices can apply to volatile memory technologies or non-volatile memory technologies. Descriptions herein referring to a “RAM” or “RAM device” can apply to any memory device that allows random access, whether volatile or nonvolatile. Descriptions referring to a “DRAM” or a “DRAM device” can refer to a volatile random access memory device. The memory device or DRAM can refer to the die itself, to a packaged memory product that includes one or more dies, or both. In one embodiment, a system with volatile memory that needs to be refreshed can also include nonvolatile memory.

Memory controller 106 represents one or more memory controller circuits or devices for system 200. Memory controller 106 represents control logic that generates memory access commands in response to the execution of operations by processor 102. Memory controller 106 accesses one or more memory devices 146. Memory devices 146 can be DRAM devices in accordance with any referred to above. Memory controller 106 includes I/O interface logic 222 to couple to a memory bus. I/O interface logic 222 (as well as I/O interface logic 242 of memory device 146) can include pins, pads, connectors, signal lines, traces, or wires, or other hardware to connect the devices, or a combination of these. I/O interface logic 222 can include a hardware interface. As illustrated, I/O interface logic 222 includes at least drivers/transceivers for signal lines. Commonly, wires within an integrated circuit interface couple with a pad, pin, or connector to interface signal lines or traces or other wires between devices. I/O interface logic 222 can include drivers, receivers, transceivers, or termination, or other circuitry or combinations of circuitry to exchange signals on the signal lines between the devices.

The exchange of signals includes at least one of transmit or receive. While shown as coupling I/O interface logic 222 from memory controller 106 to I/O interface logic 242 of memory device 146, it will be understood that in an implementation of system 200 where groups of memory devices 146 are accessed in parallel, multiple memory devices can include I/O interfaces to the same interface of memory controller 106. In an implementation of system 200 including one or more memory modules 270, I/O interface logic 242 can include interface hardware of the memory module 270 in addition to interface hardware on the memory device 146 itself. Other memory controllers 106 can include separate interfaces to other memory devices 146.

The bus between memory controller 106 and memory devices 146 can be a double data rate (DDR) high-speed DRAM interface to transfer data that is implemented as multiple signal lines coupling memory controller 106 to memory devices 146. The bus may typically include at least clock (CLK) 232, command/address (CMD) 234, and data (write data (DQ) and read data (DQO) 236, and zero or more control signal lines 238. In one embodiment, a bus or connection between memory controller 106 and memory can be referred to as a memory bus. The signal lines for CMD can be referred to as a “C/A bus” (or ADD/CMD bus, or some other designation indicating the transfer of commands (C or CMD) and address (A or ADD) information) and the signal lines for data (write DQ and read DQ) can be referred to as a “data bus.” It will be understood that in addition to the lines explicitly shown, a bus can include at least one of strobe signaling lines, alert lines, auxiliary lines, or other signal lines, or a combination. It will also be understood that serial bus technologies can be used for the connection between memory controller 106 and memory devices 146. An example of a serial bus technology is 8B10B encoding and transmission of high-speed data with embedded clock over a single differential pair of signals in each direction.

In one embodiment, one or more of CLK 232, CMD 234, Data 236, or control 238 can be routed to memory devices 146 through logic 280. Logic 280 can be or include a register or buffer circuit. Logic 280 can reduce the loading on the interface to I/O interface 222, which allows faster signaling or reduced errors or both. The reduced loading can be because I/O interface 222 sees only the termination of one or more signals at logic 280, instead of termination of the signal lines at every one or memory devices 146 in parallel. While I/O interface logic 242 is not specifically illustrated to include drivers or transceivers, it will be understood that I/O interface logic 242 includes hardware necessary to couple to the signal lines. Additionally, for purposes of simplicity in illustrations, I/O interface logic 242 does not illustrate all signals corresponding to what is shown with respect to I/O interface 222. In one embodiment, all signals of I/O interface 222 have counterparts at I/O interface logic 242. Some or all of the signal lines interfacing I/O interface logic 242 can be provided from logic 280. In one embodiment, certain signals from I/O interface 222 do not directly couple to I/O interface logic 242, but couple through logic 280, while one or more other signals may directly couple to I/O interface logic 242 from I/O interface 222 via I/O interface 272, but without being buffered through logic 280. Signals 282 represent the signals that interface with memory devices 146 through logic 280.

It will be understood that in the example of system 200, the bus between memory controller 106 and memory devices 146 includes a subsidiary command bus CMD 234 and a subsidiary data bus 236. In one embodiment, the subsidiary data bus 236 can include bidirectional lines for read data and for write/command data. In another embodiment, the subsidiary data bus 236 can include unidirectional write signal lines for write and data from the host to memory, and can include unidirectional lines for read data from the memory device 146 to the host. In accordance with the chosen memory technology and system design, control signals 238 may accompany a bus or sub bus, such as strobe lines DQS. Based on design of system 200, or implementation if a design supports multiple implementations, the data bus can have more or less bandwidth per memory device 146. For example, the data bus can support memory devices 146 that have either a ×32 interface, a ×16 interface, a ×8 interface, or another interface. The convention “×W,” where W is an integer that refers to an interface size or width of the interface of memory device 146, which represents a number of signal lines to exchange data with memory controller 106. The number is often binary, but is not so limited. The interface size of the memory devices is a controlling factor on how many memory devices can be used concurrently in system 200 or coupled in parallel to the same signal lines. In one embodiment, high bandwidth memory devices, wide interface devices, or stacked memory configurations, or combinations, can enable wider interfaces, such as a ×128 interface, a ×256 interface, a ×512 interface, a ×1024 interface, or other data bus interface width.

Memory devices 146 represent memory resources for system 200. In one embodiment, each memory device 146 is a separate memory die. Each memory device 146 includes I/O interface logic 242, which has a bandwidth determined by the implementation of the device (e.g., ×16 or ×8 or some other interface bandwidth). I/O interface logic 242 enables each memory device 146 to interface with memory controller 106. I/O interface logic 242 can include a hardware interface, and can be in accordance with I/O interface logic 222 of memory controller 106, but at the memory device end. In one embodiment, multiple memory devices 146 are connected in parallel to the same command and data buses. In another embodiment, multiple memory devices 146 are connected in parallel to the same command bus, and are connected to different data buses. For example, system 200 can be configured with multiple memory devices 146 coupled in parallel, with each memory device responding to a command, and accessing memory resources 260 internal to each. For a write operation, an individual memory device 146 can write a portion of the overall data word, and for a read operation, an individual memory device 146 can fetch a portion of the overall data word. As non-limiting examples, a specific memory device can provide or receive, respectively, 8 bits of a 128-bit data word for a Read or Write transaction, or 8 bits or 16 bits (depending for a ×8 or a ×16 device) of a 256-bit data word. The remaining bits of the word are provided or received by other memory devices in parallel.

In one embodiment, memory devices 146 can be organized into memory modules 270. In one embodiment, memory modules 270 represent dual inline memory modules (DIMMS). Memory modules 270 can include multiple memory devices 146, and the memory modules can include support for multiple separate channels to the included memory devices disposed on them.

Memory devices 146 each include memory resources 260. Memory resources 260 represent individual arrays of memory locations or storage locations for data. Typically, memory resources 260 are managed as rows of data, accessed via word line (rows) and bit line (individual bits within a row) control. Memory resources 260 can be organized as separate banks of memory. Banks may refer to arrays of memory locations within a memory device 146. In one embodiment, banks of memory are divided into sub-banks with at least a portion of shared circuitry (e.g., drivers, signal lines, control logic) for the sub-banks.

In one embodiment, memory devices 146 include one or more registers 244. Register 244 represents one or more storage devices or storage locations that provide configuration or settings for the operation of the memory device. In one embodiment, register 244 can provide a storage location for memory device 146 to store data for access by memory controller 106 as part of a control or management operation. In one embodiment, register 244 includes one or more Mode Registers. In one embodiment, register 244 includes one or more multipurpose registers. The configuration of locations within register 244 can configure memory device 146 to operate in different “mode,” where command information can trigger different operations within memory device 146 based on the mode. Additionally, or in the alternative, different modes can also trigger different operation from address information or other signal lines depending on the mode. Settings of register 244 can indicate configuration for I/O settings (e.g., timing, termination, driver configuration, or other I/O settings).

Memory controller 106 includes scheduler 110, which represents logic or circuitry to generate and order transactions to send to memory device 146. From one perspective, the primary function of memory controller 106 is to schedule memory access and other transactions to memory device 146. Such scheduling can include generating the transactions themselves to implement the requests for data by processor 102 and to maintain integrity of the data (for example, such as with commands related to refresh).

Transactions can include one or more commands, and result in the transfer of commands or data or both over one or multiple timing cycles such as clock cycles or unit intervals. Transactions can be for access such as read or write or related commands or a combination, and other transactions can include memory management commands for configuration, settings, data integrity, or other commands or a combination.

Memory controller 106 typically includes logic to allow selection and ordering of transactions to improve performance of system 200. Thus, memory controller 106 can select which of the outstanding transactions should be sent to memory device 146 in which order, which is typically achieved with logic much more complex than a simple first-in first-out algorithm. Memory controller 106 manages the transmission of the transactions to memory device 146, and manages the timing associated with the transaction. In one embodiment, transactions have deterministic timing, which can be managed by memory controller 106 and used in determining how to schedule the transactions.

Referring again to memory controller 106, memory controller 106 includes command (CMD) logic 224, which represents logic or circuitry to generate commands to send to memory devices 146. The generation of the commands can refer to the command prior to scheduling, or the preparation of queued commands ready to be sent. Generally, the signaling in memory subsystems includes address information within or accompanying the command to indicate or select one or more memory locations where the memory devices should execute the command. In response to scheduling of transactions for memory device 146, memory controller 106 can issue commands via I/O 222 to cause memory device 146 to execute the commands. Memory controller 106 can implement compliance with standards or specifications by access scheduling and control.

Referring again to logic 280, in one embodiment, logic 280 buffers certain signals 282 from the host to memory devices 146. In one embodiment, logic 280 buffers data signal lines 236 as data 286, and buffers command (or command and address) lines of CMD 234 as CMD 284. In one embodiment, data 286 is buffered, but includes the same number of signal lines as data 236. Thus, both are illustrated as having X signal lines. In contrast, CMD 234 has fewer signal lines than CMD 284. Thus, P>N. The N signal lines of CMD 234 are operated at a data rate that is higher than the P signal lines of CMD 284. For example, P can equal 2N, and CMD 284 can be operated at a data rate of half the data rate of CMD 234.

In one embodiment, memory controller 106 includes refresh logic 226. Refresh logic 226 can be used for memory resources 260 that are volatile and need to be refreshed to retain a deterministic state. In one embodiment, refresh logic 226 indicates a location for refresh, and a type of refresh to perform. Refresh logic 226 can execute external refreshes by sending refresh commands. For example, in one embodiment, system 200 supports all bank refreshes as well as per bank refreshes. All bank refreshes cause the refreshing of a selected bank 144 within all memory devices 146 coupled in parallel. Per bank refreshes cause the refreshing of a specified bank 144 within a specified memory device 146.

System 200 can include a memory circuit, which can be or include logic 280. To the extent that the circuit is considered to be logic 280, it can refer to a circuit or component (such as one or more discrete elements, or one or more elements of a logic chip package) that buffers the command bus. To the extent the circuit is considered to include logic 280, the circuit can include the pins of packaging of the one or more components, and may include the signal lines. The memory circuit includes an interface to the N signal lines of CMD 234, which are to be operated at a first data rate. The N signal lines of CMD 234 are host-facing with respect to logic 280. The memory circuit can also include an interface to the P signal lines of CMD 284, which are to be operated at a second data rate lower than the first data rate. The P signal lines of CMD 284 are memory-facing with respect to logic 280. Logic 280 can either be considered to be the control logic that receives the command signals and provides them to the memory devices, or can include control logic within it (e.g., its processing elements or logic core) that receive the command signals and provide them to the memory devices.

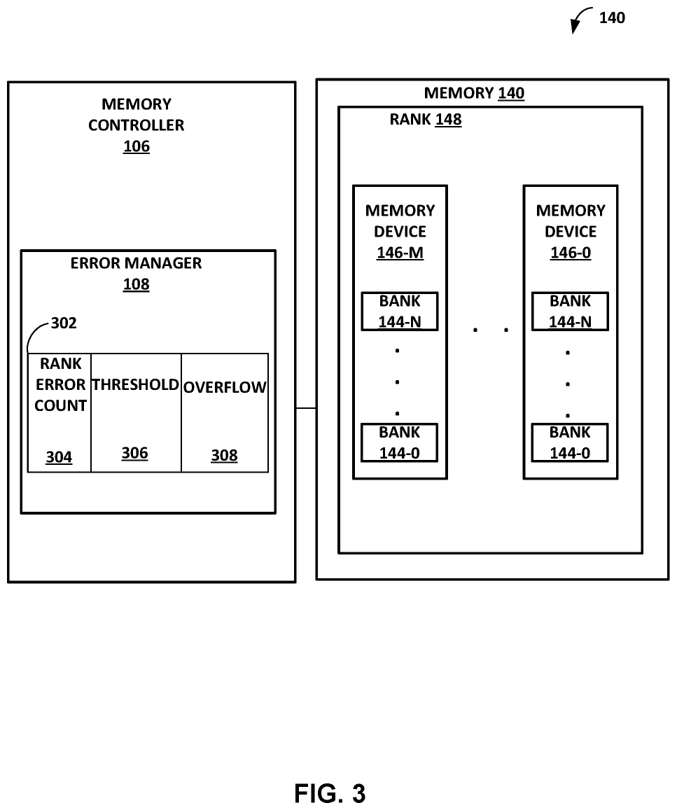

FIG. 3 is a block diagram illustrating one rank in the memory 140 and registers associated with the rank in the error manager 108 in the memory subsystem 104 shown in FIG. 1.

The rank 148 has M memory devices 146-0, . . . 146-M and each memory device has N banks 144-0, . . . 144-N. The error manager 108 includes rank registers 302 associated with the rank 148. The rank registers 302 include a rank error count 304, a threshold 306 and an overflow 308. The threshold 306 stores the threshold number of errors to trigger bank sparing in the rank 148. The rank error count 304 is incremented each time an error is detected in any of banks 144-0, . . . 144-N in any of memory devices 146-0, . . . 146-M in the rank 148.

In an embodiment where M is 18 and each memory device 146-0, . . . 146-M has four bits, 64-bits of data are stored in 16 of the memory devices, 4-bits per memory device. Error Correction Code (ECC) bits are stored in 2 of the memory devices, 4 ECC bits per memory device. The 8 ECC bits allow correcting up to 4 bits of the 64-bits of data.

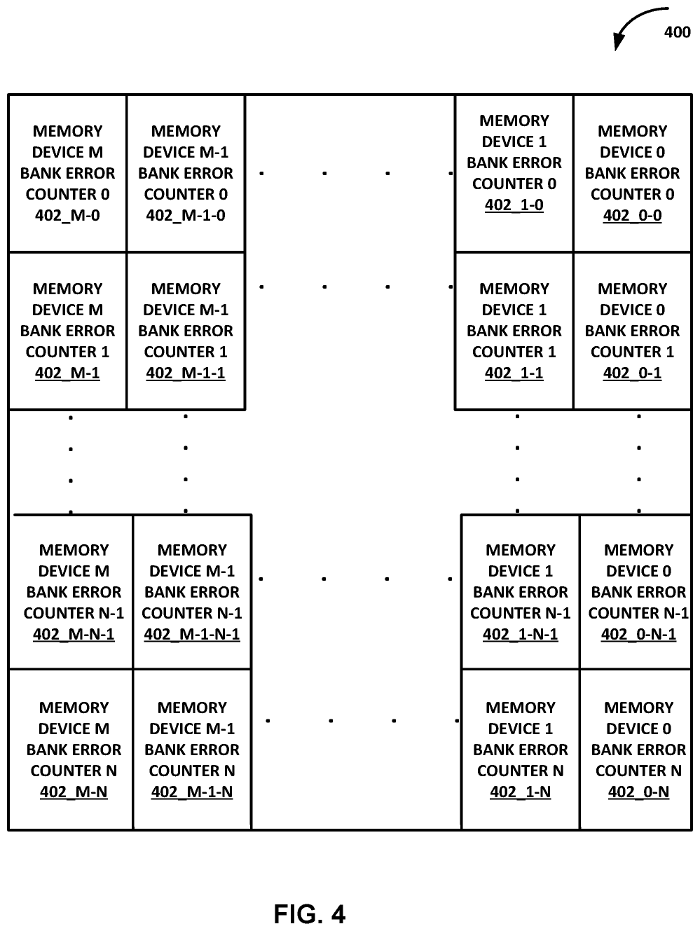

FIG. 4 is a block diagram illustrating an array of bank error counters 400 for the rank 148 shown in FIG. 3. The array of bank error counters 400 can be stored in volatile memory 140 (FIG. 3) or in a non-volatile memory. The memory to store the array of bank error counters 400 can be allocated by the BIOS. The array of bank error counters 400 includes a bank error counter 402 per bank in the rank 148. In an embodiment with M memory devices and N banks per memory device 146 in the rank 148, where M is 18 and N is 16, there are 288 bank error counters 402_0-0, . . . 402_M-N in the array of bank error counters 400.

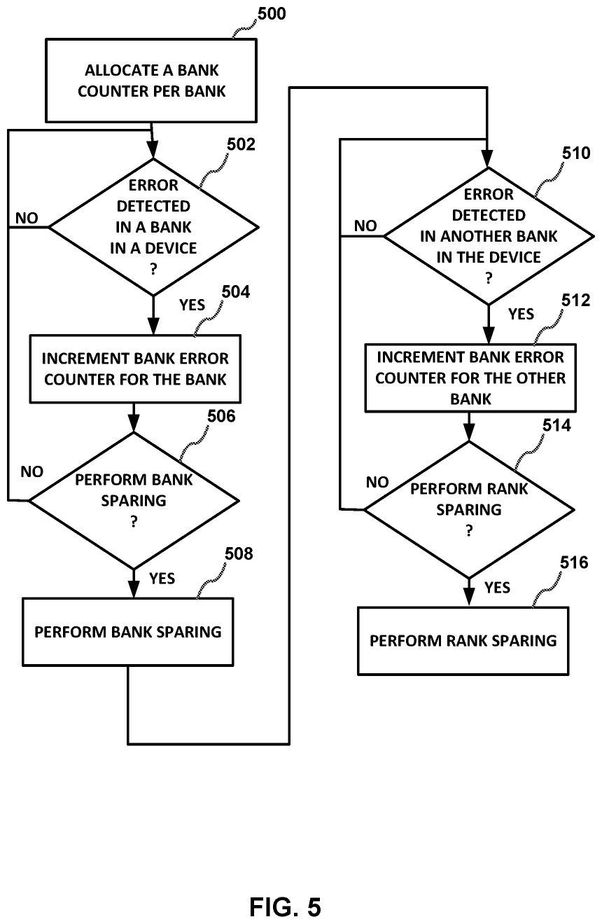

FIG. 5 is a flowgraph illustrating a method performed in the system 100 shown in FIG. 1 to perform error management using the array of bank error counters 400 for the rank 148 shown in FIG. 4.

At block 500, a bank error counter 402_0-0, . . . 402_M-N is allocated in the array of bank error counters 400 in memory 140 for each bank 144 in the rank 148. The number of bits in each bank error counter 402_0-0, . . . 402_M-N is dependent on a user selectable maximum error count for the bank 144. For example, to store a maximum error count (also referred to as an ADDDC threshold) of 0×1010 for the bank, each bank error counter 402_0-0, . . . 402_M-N has four bits.

At block 502, if a correctable error is detected in the bank 144, processing continues with block 504.

At block 504, the bank error counter 402_0-0, . . . 402_M-N for the bank 144 is incremented. Processing continues with block 506.

At block 506, if the bank error count stored in the bank error counter 402_0-0, . . . 402_M-N is greater or equal to the ADDDC threshold stored in the threshold register 306 and ADDDC bank sparing has not been performed for the failed bank 144, processing continues with block 508.

At block 508, a buddy bank in the rank 148 is selected for the failed bank. ADDDC bank sparing is performed at bank granularity to map the failed bank 144 to the buddy bank (non-failed bank) using adaptive virtual lockstep. The bank error counter 402_0-0, . . . 402_M-N for the failed bank 144 is cleared. Processing continues with block 510.

At block 510, if an error is detected in another bank 144 in the memory device 146, processing continues with block 512.

At block 512, the bank error counter 402_0-0, . . . 402_M-N for the other bank 144 is incremented. Processing continues with block 514.

At block 514, if the bank error counter 402_0-0, . . . 402_M-N for the other bank 144 equals or exceeds the threshold stored in the threshold register 306, ADDDC bank sparing has not been performed for the failed other bank and ADDDC bank sparing has been performed for a bank 402_0-0, . . . 402_M-N in the same rank 148 in the memory device 146, processing continues with block 516. A buddy rank is selected for the failed rank (the rank with the failed other bank) and ADDDC rank sparing is performed to map the failed rank to the buddy rank (non-failed rank).

At block 516, a buddy rank is selected and ADDDC rank sparing is performed to map the failed rank to the buddy rank (non-failed rank).

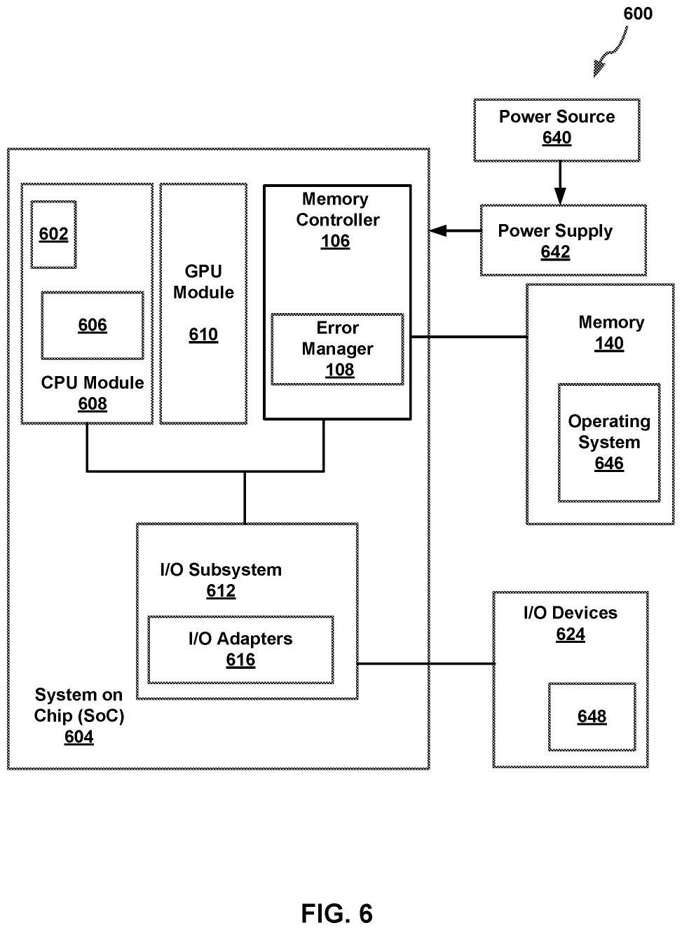

FIG. 6 is a block diagram of an embodiment of a computer system 600 that includes the memory subsystem 104. Computer system 600 can correspond to a computing device including, but not limited to, a server, a workstation computer, a desktop computer, a laptop computer, and/or a tablet computer.

The computer system 600 includes a system on chip (SOC or SoC) 604 which combines processor, graphics, memory, and Input/Output (I/O) control logic into one SoC package. The SoC 604 includes at least one Central Processing Unit (CPU) module 608, memory controller 106, and a Graphics Processor Unit (GPU) 610. In other embodiments, the memory controller 106 can be external to the SoC 604. The CPU module 608 includes at least one processor core 602 and a level 2 (L2) cache 606. The memory controller 106 is communicatively coupled to memory 140.

Although not shown, each of the processor core(s) 602 can internally include one or more instruction/data caches, execution units, prefetch buffers, instruction queues, branch address calculation units, instruction decoders, floating point units, retirement units, etc. The CPU module 608 can correspond to a single core or a multi-core general purpose processor, such as those provided by Intel® Corporation, according to one embodiment.

The Graphics Processor Unit (GPU) 610 can include one or more GPU cores and a GPU cache which can store graphics related data for the GPU core. The GPU core can internally include one or more execution units and one or more instruction and data caches. Additionally, the Graphics Processor Unit (GPU) 610 can contain other graphics logic units that are not shown in FIG. 6, such as one or more vertex processing units, rasterization units, media processing units, and codecs.

Within the I/O subsystem 612, one or more I/O adapter(s) 616 are present to translate a host communication protocol utilized within the processor core(s) 602 to a protocol compatible with particular I/O devices. Some of the protocols that adapters can be utilized for translation include Peripheral Component Interconnect (PCI)-Express (PCIe); Universal Serial Bus (USB); Serial Advanced Technology Attachment (SATA) and Institute of Electrical and Electronics Engineers (IEEE) 1594 “Firewire”.

The I/O adapter(s) 616 can communicate with external I/O devices 624 which can include, for example, user interface device(s) including a display and/or a touch-screen display 648, printer, keypad, keyboard, communication logic, wired and/or wireless, storage device(s) including hard disk drives (“HDD”), solid-state drives (“SSD”), removable storage media, Digital Video Disk (DVD) drive, Compact Disk (CD) drive, Redundant Array of Independent Disks (RAID), tape drive or other storage device. The storage devices can be communicatively and/or physically coupled together through one or more buses using one or more of a variety of protocols including, but not limited to, SAS (Serial Attached SCSI (Small Computer System Interface)), PCIe (Peripheral Component Interconnect Express), NVMe (NVM Express) over PCIe (Peripheral Component Interconnect Express), and SATA (Serial ATA (Advanced Technology Attachment)).

Additionally, there can be one or more wireless protocol I/O adapters. Examples of wireless protocols, among others, are used in personal area networks, such as IEEE 802.15 and Bluetooth, 4.0; wireless local area networks, such as IEEE 802.11-based wireless protocols; and cellular protocols.

Memory 140 can store an operating system 646. The operating system 646 is software that manages computer hardware and software including memory allocation and access to I/O devices. Examples of operating systems include Microsoft® Windows®, Linux®, i0S® and Android®.

Power source 640 provides power to the components of system 600. More specifically, power source 640 typically interfaces to one or multiple power supplies 642 in system 600 to provide power to the components of system 600. In one example, power supply 642 includes an AC to DC (alternating current to direct current) adapter to plug into a wall outlet. Such AC power can be renewable energy (e.g., solar power) power source 640. In one example, power source 640 includes a DC power source, such as an external AC to DC converter. In one example, power source 640 or power supply 642 includes wireless charging hardware to charge via proximity to a charging field. In one example, power source 640 can include an internal battery or fuel cell source.

Various embodiments and aspects of the inventions will be described with reference to details discussed below, and the accompanying drawings will illustrate the various embodiments. The following description and drawings are illustrative of the invention and are not to be construed as limiting the invention. Numerous specific details are described to provide a thorough understanding of various embodiments of the present invention. However, in certain instances, well-known or conventional details are not described in order to provide a concise discussion of embodiments of the present inventions.

Reference in the specification to “one embodiment” or “an embodiment” means that a particular feature, structure, or characteristic described in conjunction with the embodiment can be included in at least one embodiment of the invention. The appearances of the phrase “in one embodiment” in various places in the specification do not necessarily all refer to the same embodiment.

Flow diagrams as illustrated herein provide examples of sequences of various process actions. The flow diagrams can indicate operations to be executed by a software or firmware routine, as well as physical operations. In one embodiment, a flow diagram can illustrate the state of a finite state machine (FSM), which can be implemented in hardware and/or software. Although shown in a particular sequence or order, unless otherwise specified, the order of the actions can be modified. Thus, the illustrated embodiments should be understood as an example, and the process can be performed in a different order, and some actions can be performed in parallel. Additionally, one or more actions can be omitted in various embodiments; thus, not all actions are required in every embodiment. Other process flows are possible.

To the extent various operations or functions are described herein, they can be described or defined as software code, instructions, configuration, and/or data. The content can be directly executable (“object” or “executable” form), source code, or difference code (“delta” or “patch” code). The software content of the embodiments described herein can be provided via an article of manufacture with the content stored thereon, or via a method of operating a communication interface to send data via the communication interface. A non-transitory machine- readable storage media can cause a machine to perform the functions or operations described, and includes any mechanism that stores information in a form accessible by a machine (e.g., computing device, electronic system, etc.), such as recordable/non-recordable media (e.g., read only memory (ROM), random access memory (RAM), magnetic disk storage media, optical storage media, flash memory devices, etc.). A communication interface includes any mechanism that interfaces to any of a hardwired, wireless, optical, etc., medium to communicate to another device, such as a memory bus interface, a processor bus interface, an Internet connection, a disk controller, etc. The communication interface can be configured by providing configuration parameters and/or sending signals to prepare the communication interface to provide a data signal describing the software content. The communication interface can be accessed via one or more commands or signals sent to the communication interface.

Various components described herein can be a means for performing the operations or functions described. Each component described herein includes software, hardware, or a combination of these. The components can be implemented as software modules, hardware modules, special-purpose hardware (e.g., application specific hardware, application specific integrated circuits (ASICs), digital signal processors (DSPs), etc.), embedded controllers, hardwired circuitry, etc.

Besides what is described herein, various modifications can be made to the disclosed embodiments and implementations of the invention without departing from their scope.

Therefore, the illustrations and examples herein should be construed in an illustrative, and not a restrictive sense. The scope of the invention should be measured solely by reference to the claims that follow.

What is claimed is:

1. A compute device comprising:
a memory including a plurality of ranks, each rank comprising a plurality of memory devices, each memory device comprising a plurality of banks; and
circuitry to use a bank error counter per bank in the memory to perform error management of the memory.

2. The compute device of claim 1, wherein an error checking code format used to perform error management is Adaptive Double Device Data Correction (ADDDC).

3. The compute device of claim 2, wherein the circuitry to use the bank error counter to perform ADDDC bank sparing.

4. The compute device of claim 3, wherein the circuitry to perform ADDDC bank sparing if the error count for a bank equals or exceeds a per bank ADDDC threshold.

5. The compute device of claim 3, wherein the circuitry to perform ADDDC rank sparing if the error count for the bank equals or exceeds a per bank ADDDC threshold and ADDDC bank sparing has been performed for another bank in a same rank as the respective bank.

6. The compute device of claim 1, wherein the memory is a Dynamic Random Access Memory.

7. The compute device of claim 1, wherein the bank error counter is stored in the memory.

8. A system comprising:
a processor;
a memory including a plurality of ranks, each rank comprising a plurality of memory devices, each memory device comprising a plurality of banks; and
circuitry to use a bank error counter per bank in the memory to perform error management of the memory.

9. The system of claim 8, wherein an error checking code format used to perform error management is Adaptive Double Device Data Correction (ADDDC).

10. The system of claim 9, wherein the circuitry to use the bank error counter to perform ADDDC bank sparing.

11. The system of claim 10, wherein the circuitry to perform ADDDC bank sparing if the error count for a bank equals or exceeds a per bank ADDDC threshold.

12. The system of claim 10, wherein the circuitry to perform ADDDC rank sparing if the error count for the bank equals or exceeds a per bank ADDDC threshold and ADDDC bank sparing has been performed for another bank in a same rank as the respective bank.

13. The system of claim 8, wherein the memory is a Dynamic Random Access Memory.

14. The system of claim 8, wherein the bank error counter is stored in the memory.

15. The system of claim 8, further comprising one or more of:
a display communicatively coupled to the processor; or
a battery coupled to the processor.

16. One or more non-transitory machine-readable storage media comprising a plurality of instructions stored thereon that, in response to being executed, cause a system to:
store data in a memory, the memory including a plurality of ranks, each rank comprising a plurality of memory devices, each memory device comprising a plurality of banks; and
perform error management of the memory using a bank error counter per bank in the memory.

17. The one or more non-transitory machine-readable storage media of claim 16, wherein an error checking code format used to perform error management is Adaptive Double Device Data Correction (ADDDC).

18. The one or more non-transitory machine-readable storage media of claim 17, wherein the bank error counter is used to perform ADDDC bank sparing.

19. The one or more non-transitory machine-readable storage media of claim 18, wherein ADDDC bank sparing is performed if the error count for the respective bank equals or exceeds a per bank ADDDC threshold.

20. The one or more non-transitory machine-readable storage media of claim 18, wherein ADDDC rank sparing is performed if the error count for the respective bank equals or exceeds a per bank ADDDC threshold and ADDDC bank sparing has been performed for another bank in a same rank as the respective bank.

21. The one or more non-transitory machine-readable storage media of claim 16, wherein the memory is a Dynamic Random Access Memory.

22. The one or more non-transitory machine-readable storage media of claim 16, wherein the bank error counter is stored in the memory.
